(19) United States
(12) Patent Application Publication
(10) Pub. No.: US 2011/0023703 A1
(43) Pub. Date: Feb. 3, 2011

(54) TAMPER RESISTANT SPRING BRAKE ACTUATOR

(76) Inventor: JERRY RADOWITZ, Hampstead (CA)

Correspondence Address: FLEIT GIBBONS GUTMAN BONGINI & BIANCO P.L., ONE BOCA COMMERCE CENTER, 551 NORTHWEST 77TH STREET, SUITE 111, BOCA RATON, FL, 33487, US

(21) Appl. No.: 12/533,843

(22) Filed: Jul. 31, 2009

(51) Int. Cl. B60T 17/08; F01B 7/00

(52) U.S. Cl. 92/63; 92/94

(57) ABSTRACT

A tamper resistant spring brake actuator with a stroke position indicator has a cover attached to a flange case by a removable clamp, with a head permanently attached to the flange case by a one-piece continuous clamp member, which is permanently deformed in place during assembly. The cover, flange case and head have annular rims, which are relatively flat and smooth. The one-piece continuous clamp ring is in contact with and clamps the outer flanges of the flange case, the parking chamber diaphragm and the head. The stroke position indicator can be treated with a surface protector to minimize the accumulation of oil and road debris.

### FIELD OF THE INVENTION

The present invention pertains to an improved spring brake actuator for large motor vehicles, which include a stroke position indicator and simplified construction.

### BACKGROUND

Brake systems for large motor vehicles such as trucks, tractors and buses typically include brake actuators to operate the brake shoe and drum assembly. Most commercially available air brake actuators include a service brake actuator and an emergency brake actuator. Under normal operating conditions, the service brake actuator applies the brakes through the application of compressed air.

Most emergency brake actuators include a power spring that applies the brakes when the air pressure drops below a pre-determined threshold. These types of actuators are commonly referred to as spring brake actuators. Under normal operating conditions, a chamber in the spring brake actuator is filled with compressed air. One wall of the chamber is moveable, and typically includes a diaphragm. As the air pressure in the chamber is increased, the diaphragm acts against the power spring to compress the power spring.

In the event of a loss of air pressure, or an intentional exhaustion of air from the spring brake actuator chamber, the brake is mechanically activated by the force of the power spring acting on a spring brake actuator rod that acts upon the service brake actuator or directly to activate the brakes. As such, the spring brake actuator functions both as a parking brake and an emergency brake.

In order to generate sufficient force to activate the brakes in a large motor vehicle, the power spring must be capable of storing a large amount of energy. As such, power springs are large and very heavy. The spring brake actuator housing must also be strong, and fabricated using sufficiently thick material to contain the power spring, and to provide an adequate foundation to absorb the reaction force of the power spring as it presses against the base of the housing. The housing must also be designed to withstand these loads during years of continuous exposure in a wide range of operating conditions.

Since a large amount of energy is stored in the power spring, most spring brake actuators are tamper resistant to avoid the accidental release of the power spring, which could result in considerable injury or death. Even when the power spring is fully expanded, it is still highly compressed and exerts a force within the chamber of as much as 1,000-1,200 pounds or more. Many tamper resistant spring brake actuators are permanently sealed during the assembly process by clamping together the flanges located at the perimeter of the head and the flange case using a conventional bolted clamp band or a continuous ring which is deformed in place. These techniques to permanently seal the head to the flange case, such as those disclosed in Canadian Patent No. 1,306,425 to Indian Head Industries Inc. were adapted from well known prior art including but not limited to U.S. Pat. No. 3,101,133 to B. E. House et al., U.S. Pat. No. 3,101,219 to D. B. Herrera, U.S. Pat. No. 3,136,227 to W. J. Williams et al., U.S. Pat. No. 3,244,079 to D. B. Herrera, U.S. Pat. No. 3,439,585 to D. B. Herrera, U.S. Pat. No. 3,478,519 to G. Eggstein, U.S. Pat. No. 3,515,438 to B. E. Stevenson et al., German Patent Publication No. 7,308,049 to R. Bosch GMBH, French Patent Publication No. 2,220,161 to R. Bosch GMBH, Canadian Patent No. 1,071,668 to S. S. Helmus, U.S. Pat. No. 4,565,120 to K. J. Gray et al., Great Britain Patent Publication No. 2,196,071 to G. A. Beesley, Canadian Patent No. 1,242,235 to L. R. Myers, European Patent Publication No. 0313217 to P. Jennison, U.S. Pat. No. 4,960,036 to A. L. Gummer, U.S. Pat. No. 5,067,391 to G. J. Choinski et al., U.S. Pat. No. 5,205,205 to G. J. Choinski et al., U.S. Pat. No. 5,263,403 to G. J. Choinski et al., U.S. Pat. No. 5,311,809 to G. J. Choinski et al., U.S. Pat. No. 5,433,138 to G. J. Choinski et al., European Patent No. EP 0315463 B1 to A. L. Gummer et al., and European Patent No. EP 0315463 B2 to A. L. Gummer.

The upper and lower surfaces of the flanges of the prior art located at the perimeter of the head and the flange case are typically rounded and/or uneven. When a diaphragm is positioned between these surfaces and clamped together, the resulting seal is subject to failure after prolonged use, as the uneven surface of the flanges may cause premature wear on the diaphragm.

In addition, current tamper resistant brake actuators must be manufactured and assembled by highly skilled individuals using complex assembly tools that collectively increase the cost of the final assembled spring brake actuator. Given the quantity of large motor vehicles in service, even a modest reduction in spring brake actuator manufacturing and assembly costs would result in a tremendous savings and net benefit to consumers.

Spring brake actuators have a predetermined amount of available movement of the push rod or stroke of the push rod. The amount of movement of the push rod to fully actuate the braking system of the vehicle must be carefully monitored, such that it is within the stroke of the push rod of the brake actuator. Excessive movement of the push rod can occur by several reasons. Usually, excessive movement of the push rod is due to brake lining wear. As the brakes wear, more movement of the push rod is required to actuate the brakes. Further, as the linkages and connections between the push rods and the linkages bend, become loose or excessively worn, additional push rod movement may be required to actuate the brakes. A combination of several of these factors may cause the amount of push rod movement required to actuate the brakes to approach the maximum amount of available push rod movement or stroke available from the spring brake actuator. This is an extremely undesirable situation.

Various approaches have been developed to monitor the amount of push rod movement during actuation of the brakes and provide an indication when there is excessive push rod movement, which is often referred to as “overstroke”. The push rod of a typical brake actuator includes a brightly coloured ring, which indicates an overstroke condition when the ring extends out of the brake actuator during actuation of the brakes. This brightly coloured ring, or stroke position indicator is usually bright orange in colour as discussed in U.S. Pat. No. 5,523,862 to Hanaway et al. and U.S. Pat. No. 6,255,941 to Osterman et al.

Accordingly a need exists for an improved tamper resistant spring brake actuator, having a stroke position indicator that can be economically manufactured and assembled without compromising safety.

### SUMMARY OF THE INVENTION

In accordance with the present invention, a tamper resistant spring brake actuator is provided with a stroke position indicator. The spring brake actuator cover is attached to the flange case by a removable clamp, and the spring brake actuator head is permanently attached to the flange case by a one-piece continuous clamp ring, which is deformed in place during assembly. The flange case and head include annular rims, which are relatively flat and smooth.

The one-piece continuous clamp ring engages the outer rims of the head and the flange case of the spring brake actuator to compress a diaphragm, which is housed within the chamber formed by the flange case, and the head. In this embodiment, the edge of the diaphragm is completely encased by the one-piece continuous ring clamp. Optionally, the stroke position indicator is treated with a surface protector to minimize the accumulation of oil and road debris.

### BRIEF DESCRIPTION OF THE FIGURES

FIG. 1 is a perspective view of one embodiment of the spring brake actuator according to the present invention;

FIG. 2 is a front view of one embodiment of the spring brake actuator according to the present invention;

FIG. 3 is an exploded parts view of the cover and the flange case of one embodiment of the spring brake actuator according to the present invention;

FIG. 4 is an exploded parts view of the flange case and the head of one embodiment of the spring brake actuator according to the present invention;

FIG. 5a is a cross-sectional view of one embodiment of the spring brake actuator according to the present invention showing the one-piece continuous ring clamp deformed to permanently secure the flange case to the head;

FIG. 5b is a cross-sectional view of one embodiment of the spring brake actuator according to the present invention with the returning spring being depicted in its at-rest position, fully-expanded state within the service chamber;

FIG. 6 is a cross-sectional view of one embodiment of the spring brake actuator according to the present invention with the returning spring being depicted in the brake-applied position within the service chamber and depicting the maximum stroke;

FIG. 7 is a cross-sectional view of one embodiment of the spring brake actuator according to the present invention with the parking spring being depicted in a fully-expanded state within the parking chamber and depicting the maximum stroke; and

FIG. 8 is a cross-sectional view of one embodiment of the spring brake actuator according to the present invention with the parking spring being depicted in a fully-compressed state by means of a release bolt.

It should be understood that the drawings are not to exact scale and that when referring to physical relationships of components, the terms usually have reference to the orientation depicted in the drawings. Actual embodiments for specific installations may differ both structurally and dimensionally, depending upon the particular vehicles for which the braking systems are designed.

### DETAILED DESCRIPTION OF THE INVENTION

The present invention is now described with reference to the drawings. In the following description, for purposes of explanation, numerous specific details are set forth in order to provide a thorough understanding of the present invention. It may be evident, however that the present invention may be practiced without these specific details.

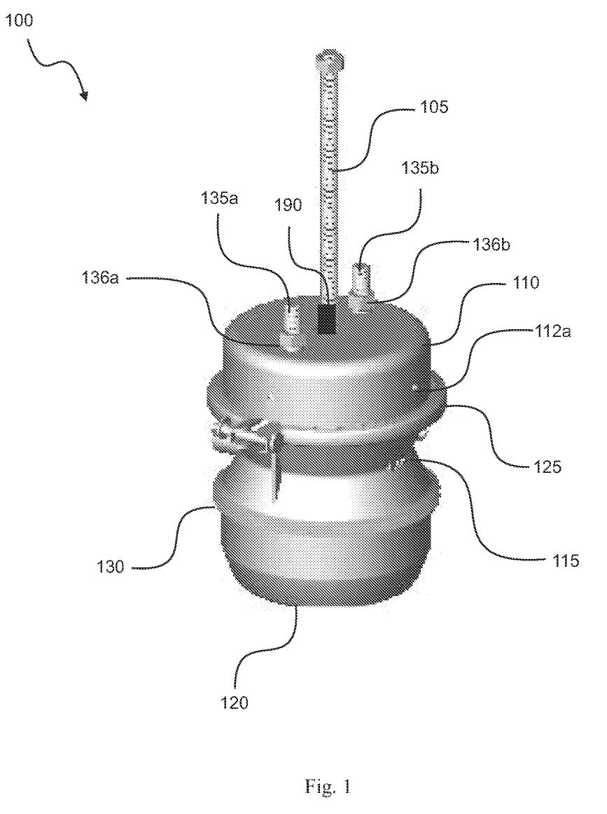

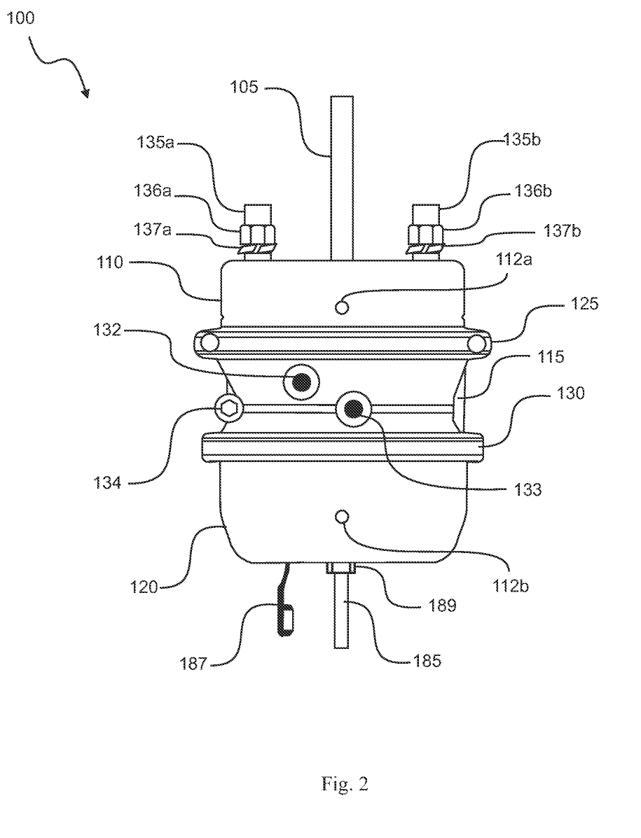

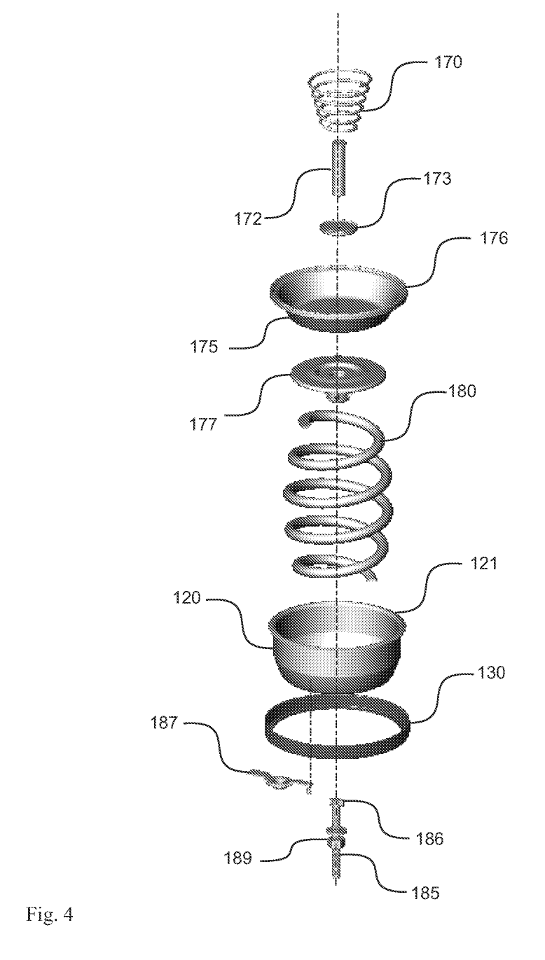

Referring to FIGS. 1 to 4 one embodiment of the tamper resistant spring brake actuator in accordance with the present invention is shown. Spring brake actuator 100 includes push rod 105, cover 110, flange case 115 and head 120. Cover 110 is secured to flange case 115 by bolted clamp band 125 to form a first chamber called the service chamber. Head 120 is secured to flange case 115 by one-piece continuous ring clamp 130 to form a second chamber called the parking chamber. Continuous ring clamp 130 is deformed in place during assembly of the brake actuator to permanently secure head 120 to flange case 115. Spring brake actuator 100 is secured to the support structure on the vehicle adjacent to the brake actuator arm (not shown) by means of bolts 135a and 135b with nuts 136a and 136b and spring washers 137a and 137b respectively. The exposed portion of push rod 105 is secured to the vehicle brake assembly (not shown).

Cover 110 is generally cylindrical, and includes a radially extending annular rim 111, one or more vents 112a and an opening 113 to receive push rod 105. Head 120 is also generally cylindrical, a radially extending annular rim 121, one or more vents 112b and an opening (not shown) to receive release bolt 185. Cover 110 and head 120 are manufactured using a high strength metal alloy, such as steel, which may be treated with a corrosion inhibitor, such as yellow zinc (Cr6). Flange case 115 includes radially extending annular rims 116 and 117 and pneumatic ports 132 and 133. Flange case 115 is cast from a relatively light durable material such an aluminum alloy. Optionally, flange case 115 further comprises a receptacle 134, which is adapted to hold release bolt 185 with release nut 189.

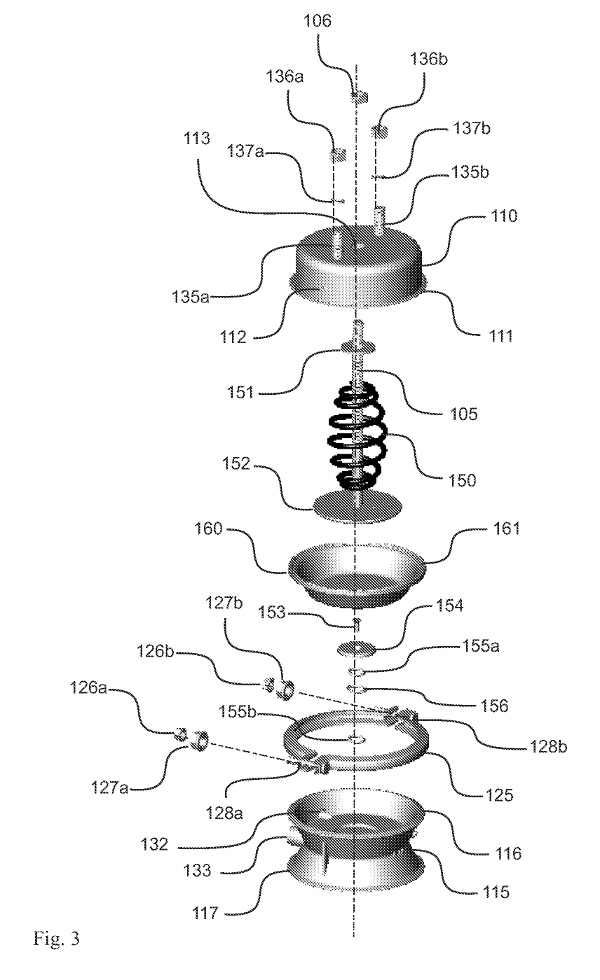

Housed within the service chamber are returning spring 150, rod end spring seat 151, push rod assembly plate 152, countersink screw 153, push disc 154, nylon guides 155a and 155b, seal 156 and service chamber diaphragm 160. During assembly of spring brake actuator 100, push rod assembly plate 152 is coupled to connecting rod 105, which is inserted through returning spring 150 as depicted in FIG. 3. Rod end spring seat 151 is positioned on connecting rod 105 adjacent to returning spring 150 which protects the inside surface of cover 110 from direct contact with returning spring 150. Countersink screw 153 is inserted through push disc 154, nylon guide 155a, seal 156, nylon guide 155b and flange case 115 and coupled to connecting rod 172.

Bolted clamp band 125 is secured by hex nuts 126a and 126b, flanged hex nuts 127a and 127b and clamp bolts 128a and 128b. Service chamber diaphragm 160 is formed of a flexible, resilient material such as rubber, neoprene, fabric center reinforced neoprene or a material with similar properties. Service chamber diaphragm 160 is concave in shape, and comprises a rim portion 161.

During assembly of spring brake actuator 100, rim portion 161 of service chamber diaphragm 160 is positioned between annular rims 111 and 116 of cover 110 and flange case 115, respectively. Annular rims 111 and 116 are pressed together on either side of rim portion 161 of service chamber diaphragm 160 and are clamped in place by bolted clamp band 125.

Housed within the parking chamber are returning spring 170, connecting rod 172, push plate 173, parking chamber diaphragm 175, spring plate 177 and parking spring 180. During assembly of spring brake actuator 100, connecting rod 172 is positioned within returning spring 170, which is positioned between flange case 115 and push plate 173 as indicated in FIG. 3. Spring plate 177 is positioned adjacent to parking chamber diaphragm 175. Parking spring 180 is position between spring plate 177 and head 120. Both the service chamber diaphragm 160 and parking chamber diaphragm 175 may be made from the same material and comprise the same characteristics.

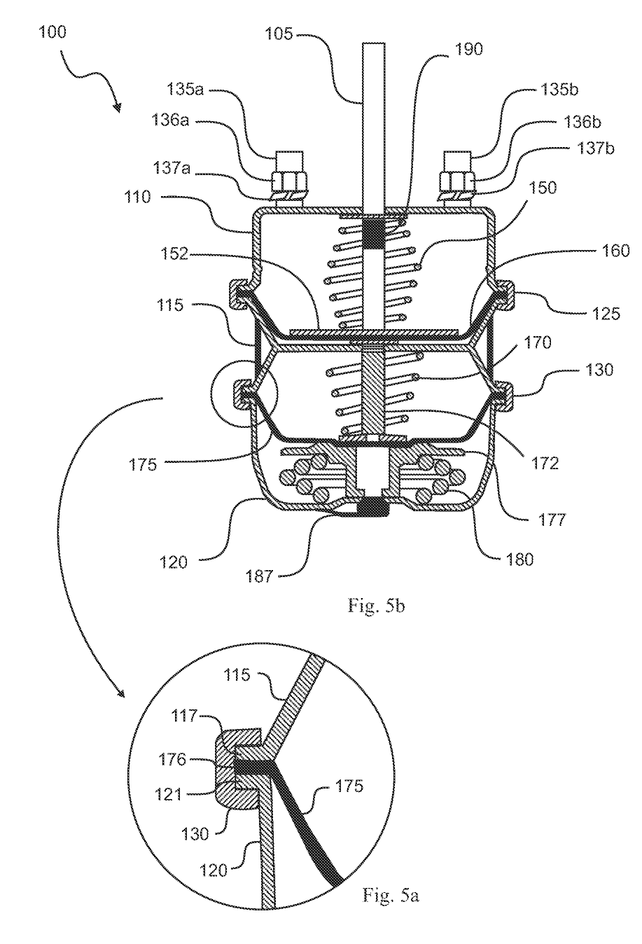

During assembly, rim portion 176 of parking chamber diaphragm 175 is positioned between annular rims 117 and 121 of flange case 115 and head 120 respectively. Annular rims 117 and 121 are pressed together on either side of rim portion 176 of parking chamber diaphragm 175 and are permanently compressed by continuous ring clamp 130 as shown in FIGS. 5a and 5b.

As shown in FIG. 5a, the upper and lower surfaces of annular rims 117 and 121 that contact rim portion 176 of parking chamber diaphragm 175 and continuous ring clamp 130 are relatively flat and smooth. In addition, rim portion 176 of parking chamber diaphragm 175 is substantially or completely encased by continuous ring clamp 130, which provides for a permanent, sealed parking chamber. Continuous ring clamp 130 also protects the edges of annular rims 117 and 121 and rim portion 176 of parking chamber diaphragm 175 from corrosion thereby extending the duration of service.

As a result of the force exerted by bolted clamp band 125 and continuous ring clamp 130, the configuration of annular rims 111, 116, 117 and 121, service chamber diaphragm 160 and parking chamber diaphragm 175 each form a hermetic or air-tight seal within the service chamber and parking chamber respectively. The relatively flat and smooth surfaces of annular rims 117 and 121 increases the strength of the air-tight seal, which extends the duration of service for parking chamber diaphragm 175.

Pneumatic ports 132 and 133 are connected to the pneumatic braking system of the vehicle (not shown) and are used to pressurize the service chamber and parking chamber respectively. Vents 112a and 112b are connected to an external tube breather system located on the vehicle (not shown), which allows clean air free of debris to enter the service chamber and the parking chamber.

Referring to FIG. 5b, spring brake actuator 100 is shown with the returning spring being depicted in its at-rest position, fully-expanded state within the service chamber. The parking chamber contains compressed air received through pneumatic port 133 (not shown), which drives parking chamber diaphragm 175 downwardly, compressing parking spring 177.

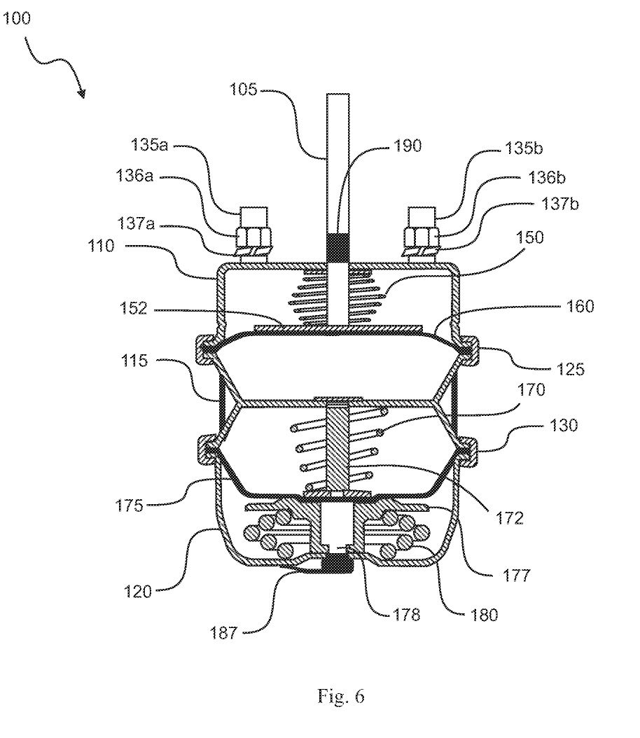

Upon actuation of the vehicle brake pedal, compressed air is received through pneumatic port 132 (not shown), which drives service chamber diaphragm 160 towards cover 110 as shown in FIG. 6. Service chamber diaphragm 160 inverts against push rod assembly plate 152, to force push rod 105, thereby actuating the vehicle brakes (not shown). Upon release of the brake pedal, the pressure in the service chamber decreases, and returning spring 150 pushes push rod assembly plate 152 towards service chamber diaphragm 160 to the position shown in FIG. 5b. As service chamber diaphragm 160 moves in response to the depressurization of the service chamber, and the movement of push rod assembly plate 152, air enters the service chamber through vents 112a, which are connected to an external tube breather system located on the vehicle (not shown).

When spring brake actuator 100 is in the brake-applied position as shown in FIG. 6, the maximum stroke of push rod 105 is readily detectable to an observer by means of a stroke position indicator 190 on push rod 105. In the brake-applied position, stroke position indicator 190 provides a visual indication of brake wear and/or the need for adjustment of slack adjusters or brake lining replacement. Stroke position indicator 190 may be placed at any location on push rod 105 so long as stroke position indicator 190 allows for visual inspection of the stroke of push rod 105.

Stroke position indicator 190 is typically painted in brightly coloured, preferably orange paint to facilitate visual inspection, which is applied to the surface of push rod 105. Stroke position indicator 190 may, however be difficult to see depending upon the location of the brake actuators beneath the vehicle and the amount of accumulated road debris on push rod 105. To minimize the amount of accumulated road debris, an optional clear no-stick surface protector, such as polytetrafluoroethylene, is applied to the surface of stroke position indicator 190.

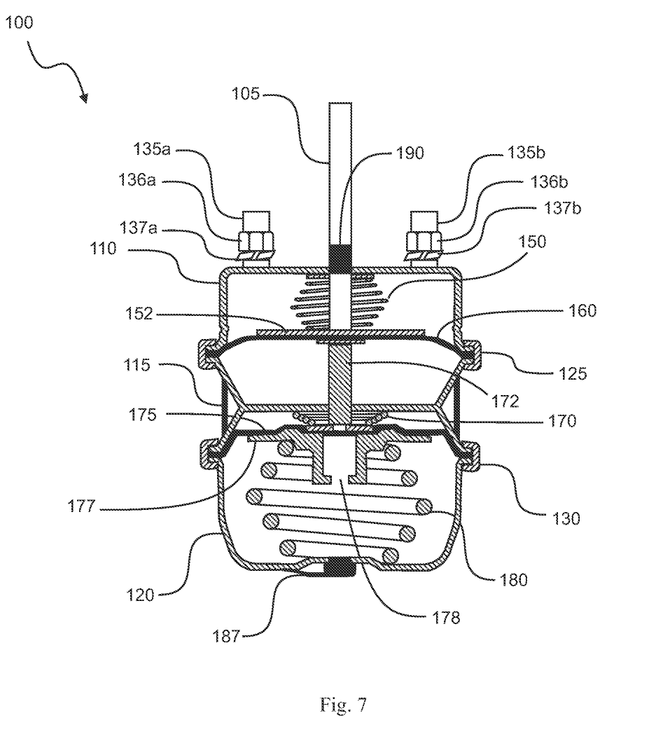

Referring to FIG. 7, spring brake actuator 100 is shown in the parking or emergency brake mode. When the operator of the vehicle engages the parking brake, the parking chamber is depressurized resulting in the expansion of parking spring 180. As parking spring 180 expands, parking chamber diaphragm 175 is driven against spring plate 177. The motion of spring plate 177 drives connecting rod 172 against push disc 154, which in turn drives service chamber diaphragm 160 and push rod 105 to actuate the vehicle brakes. As shown in FIG. 7, returning springs 150 and 170 are both compressed by parking spring 180 in this mode. Therefore, the spring constant of parking spring 180 is considerably larger than that of returning springs 150 and 170 in combination. In the event of a failure of the pneumatic braking system of the vehicle, the loss of air pressure in the parking chamber also enables the spring brake actuator 100 to act as an emergency brake.

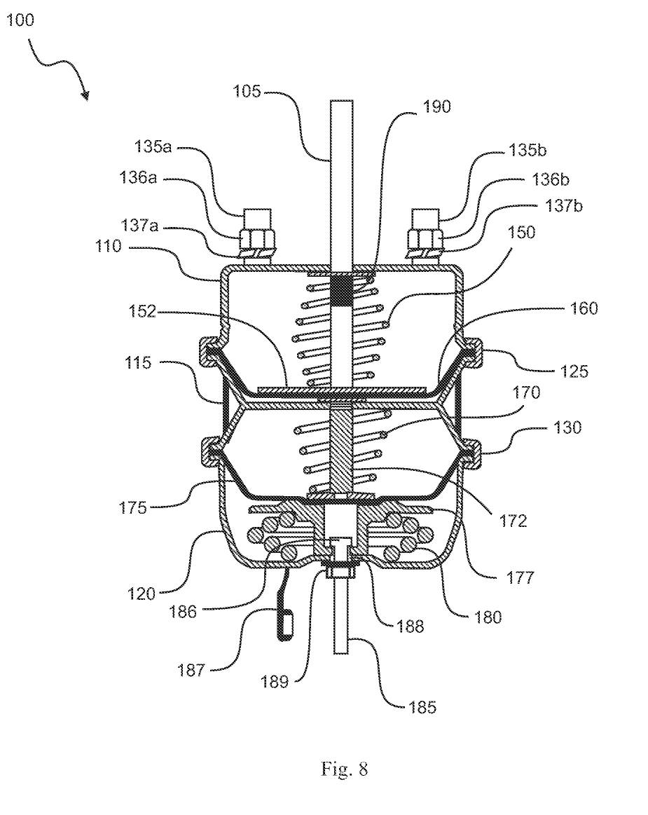

Referring to FIG. 8, spring brake actuator 100 is shown with parking spring 180 in a fully-compressed state by means of release bolt 185. Protector 187 is disengaged from release bolt opening 188 in this mode. When spring brake actuator 100 is in the parking or emergency brake mode, it is occasionally necessary to manually release the vehicle brakes to move the vehicle in the absence of air pressure or to service the brakes. Release bolt 185 is threaded lengthwise and may be manually threaded axially inwardly or outwardly. Release bolt 185 has an enlarged distal end 186 having a diameter larger than the inner periphery of slot 178 of spring plate 177. In some embodiments, release bolt 185 and release nut 189 are optionally stored within receptacle 134 as previously discussed.

To manually release the vehicle brakes, release bolt 185 is inserted into the release bolt opening 188 on head 120, and rotated until distal end 186 engages spring plate 177. Release nut 189 is tightened until parking spring 180 is fully compressed as illustrated in FIG. 8. Release bolt 185 is detachable, and when detached, protector 187 is used to seal the release bolt opening 188 on head 120 as shown in FIGS. 5a, 6, and 7.

The spring brake actuator 100 of the present invention may be mounted in any orientation, generally beneath a truck or a trailer, wherein each axle includes a spring brake actuator. The stroke position indicator 190 enables the vehicle operator to visually monitor the amount of push rod movement during actuation of the brakes and provide an indication when there is excessive push rod movement. In addition, the stroke position indicator 190 can be coated to minimize the accumulation of road debris.

Although the description above contains many specific details, these should not be construed as limiting the scope of the embodiments but as merely providing illustrations of some of the presently preferred embodiments. Thus the scope of the embodiments should be determined by the appended claims and their legal equivalents, rather than by the examples given.

What is claimed:

1. A tamper resistant spring brake actuator device comprising:
a flange case having a pair of opposed chamber portions defining portions of a service chamber and a parking chamber respectively, the flange case having a first annular flange being relatively smooth and flat extending generally radially outwardly from the portion defining part of the service chamber, a second annular flange being relatively smooth and flat extending generally radially outwardly from the portion defining part of the parking chamber, a first pneumatic port for pressurizing the service chamber and a second pneumatic port for pressurizing the parking chamber;
a cover defining a portion of the service chamber and adapted to couple to a support structure of a vehicle; said cover comprising:
a third annular flange being relatively smooth and flat extending generally radially outwardly from the portion defining part of the service chamber; and
one or more vents;
a flexible and resilient service chamber diaphragm; said diaphragm disposed between the cover and the flange case;
a returning spring disposed between the cover and the service chamber diaphragm and biasing the service chamber diaphragm towards the flange case;
a push rod assembly plate disposed between the cover and the service chamber diaphragm;
a push rod mounted in contact with the push rod assembly plate and extending outwardly through the returning spring and the cover; said push rod adapted to be connected to a vehicle brake assembly;
a stroke position indicator applied to the push rod;
a head defining a portion of a parking chamber; said head having an annular flange being relatively smooth and flat extending generally radially outwardly from a portion defining part of the parking chamber; and at least one vent;
a head defining a portion of a parking chamber; said head comprising:
a fourth annular flange being relatively smooth and flat extending generally radially outwardly from a portion defining part of the parking chamber; and
one or more vents;
a parking chamber diaphragm being flexible and resilient disposed between the flange case and the head;
a spring plate mounted between the parking chamber diaphragm and the head;
a power spring disposed between the spring plate and the head;
a returning spring disposed between the parking chamber diaphragm and the flange case;
a connecting rod mounted in contact with a push plate and extending inwardly through the returning spring and the flange case;
a releasable clamp member clamping the third annular flange to the first annular flange;
a permanent clamp member in contact with and clamping the second annular flange to the parking chamber diaphragm and the fourth annular flange, the permanent clamp member being deformed beyond its elastic limit around the second annular flange, parking chamber diaphragm and fourth annular flange, to permanently retain the head in contact with the parking chamber diaphragm and the flange case, whereby to remove the head from the flange case, the permanent clamp member must be deformed beyond its elastic limit;
wherein said stroke position indicator is adapted to facilitate inspection of the stroke of the push rod.

2. The device of claim 1, wherein the releasable clamp member is a bolted clamp band.

3. The device of claim 1, wherein the permanent clamp member is a one-piece continuous ring clamp.

4. The device of claim 1, further comprising a release bolt having a distal end and a threaded end, the head adapted to receive the release bolt and the spring plate adapted to releasably engage the release bolt.

5. The device of claim 4, wherein the flange case further comprises a receptacle to releasably receive the release bolt.

6. The device of claim 1, wherein the stroke position indicator further comprises a surface protector.

7. The device of claim 6, wherein the surface protector is polytetrafluoroethylene.

8. The device of claim 1, wherein the material for the cover and the head is a steel alloy.

9. The device of claim 1, wherein the material for the flange case is an aluminum alloy.

10. The device of claim 1, wherein at least one of the cover, the head, the push rod, the connecting rod, the first returning spring, the second returning spring, the parking spring, the releasable clamp member, the permanent clamp member is treated with a corrosion inhibitor.

11. The device of claim 10, wherein the corrosion inhibitor is yellow zinc (Cr6).

12. The device of claim 1, wherein the material for the service chamber diaphragm and the parking chamber diaphragm are chosen from the group consisting of rubber, neoprene or fabric center reinforced neoprene.
